(19) United States
(12) Patent Application Publication
(10) Pub. No.: US 2024/0430617 A1
(43) Pub. Date: Dec. 26, 2024

(54) BLUETOOTH SPEAKER NETWORKING SYSTEM AND INTERCONNECTION BROADCASTING METHOD THEREOF

(71) Applicant: Zhuhai Rongyuan Electronic Technology Co., LTD, Zhuhai (CN)

(72) Inventors: Huangbo Lan, Zhuhai (CN); Yan He, Zhuhai (CN)

(21) Appl. No.: 18/823,920

(22) Filed: Sep. 4, 2024

Related U.S. Application Data
(63) Continuation of application No. PCT/CN2024/070065, filed on Jan. 2, 2024.

(30) Foreign Application Priority Data
Dec. 18, 2023 (CN) 202311738860.0

(51) Int. Cl. H04R 3/12; G06F 3/16

(52) U.S. Cl. CPC H04R 3/12; G06F 3/165; H04R 2420/03; H04R 2420/07

(57) ABSTRACT

A Bluetooth speaker networking system including a number of Bluetooth sound units in wireless communication connection with each other is provided. When all Bluetooth sound units are powered on, the Bluetooth sound units are set as auxiliary Bluetooth sound units by default. When any one Bluetooth sound unit is connected with external equipment through Bluetooth, the Bluetooth sound unit is set as a host Bluetooth sound and all other auxiliary machine Bluetooth sound equipment are connected with the main machine Bluetooth sound equipment, and the Bluetooth of the auxiliary machine Bluetooth sound equipment is closed. The host Bluetooth sound synchronizes the received audio signal to all other auxiliary Bluetooth sound.

### TECHNICAL FIELD

The disclosure relates to the technical field of intelligent speakers, and more specifically, to a Bluetooth speaker networking system and an interconnection broadcasting method thereof.

### BACKGROUND ART

Recently, with the rise of smart home technologies, speakers are becoming an integral part of home entertainment and life. More and more places are internally provided with speakers so as to improve the audio playing effect.

The current intelligent speaker adopts an integrated structure, and a control chip, a loudspeaker, a microphone and other corresponding modules are arranged internally in the integrated structure. Speakers employ a number of key technologies to perform their functions, which primarily includes speaker technologies consisting of the design of diaphragm materials, voice coils, and magnetic systems, as well as the power and efficiency of sound amplifiers. Secondly, the speaker includes the wireless communication technologies consisting of the Bluetooth, Wi-Fi or other wireless protocols to connect with other devices. There are also audio and video encoding and decoding techniques for processing and transmitting audio signals. However, the power module generally provides integrated power for each module, and an orderly power supply system cannot be built according to the actual situation of each module.

In addition, in the existing technologies, an amplifier is established by utilizing an audio DSP processor and a power amplifier IC driving and constructing network, and the audio amplification and the transverse and traditional Bluetooth module technology can carry out data transmission through serial port control equipment. And there are two kinds of modules that divide the speaker into a master and a slave. The master mode can search the Bluetooth module through the Bluetooth device and actively establish connection with the Bluetooth module, but the slave mode cannot actively establish connection, and a plurality of speakers cannot establish effective interconnection influence.

Therefore, there is an urgent need for those skilled in the art to design a Bluetooth speaker networking system to realize more stable and diversified use of the speaker.

### SUMMARY

In view of this, the disclosure provides a Bluetooth speaker networking system, which improves the efficiency of the power amplifier module, the Bluetooth module and the broadcast receiving module, so that the Bluetooth speaker networking system can work more stably and with high quality when playing audio.

In order to achieve the above purpose, the present invention adopts the following technical scheme as follows.

A Bluetooth speaker networking system including a number of Bluetooth sound units in wireless communication connection with each other is provided.

When all Bluetooth sound units are powered on, the Bluetooth sound units are set as auxiliary Bluetooth sound units by default.

When any one Bluetooth sound unit is connected with external equipment through Bluetooth, the Bluetooth sound unit is set as a host Bluetooth sound.

All other auxiliary machine Bluetooth sound equipment are connected with the main machine Bluetooth sound equipment, and the Bluetooth of the auxiliary machine Bluetooth sound equipment is closed.

The host Bluetooth sound synchronizes the received audio signal to all other auxiliary Bluetooth sound.

Preferably, the Bluetooth sound unit includes a power supply module, a Bluetooth module, a broadcast receiving module, a power amplifier module and a loudspeaker.

The power module includes a first DC-DC converter and a second DC-DC converter. The first DC-DC converter is connected with the power amplification module and is used for reducing voltage to supply power for the power amplification module. The second DC-DC converter is connected with the Bluetooth module and the broadcast receiving module and is used for reducing voltage to supply power for the Bluetooth module and the broadcast receiving module.

The Bluetooth module is used for receiving an audio signal sent by external equipment, is connected with the broadcast receiving module and transmits the audio signal to the broadcast receiving module. The broadcast receiving module is used for determining an auxiliary machine mode and a main machine mode of the Bluetooth sound equipment, is connected with the power amplification module and transmits the audio signal to the power amplification module; the power amplifier module is connected with a loudspeaker and drives the loudspeaker to sound.

Preferably, when all Bluetooth sound units are powered on, the broadcast receiving module sets the local Bluetooth sound unit as a secondary Bluetooth sound.

After any one of the Bluetooth sound units is connected with the peripheral through Bluetooth, the Bluetooth module sends a connection signal to the broadcast receiving module, the broadcast receiving module receives the connection signal, and the local Bluetooth sound unit is set as a host Bluetooth sound unit.

Preferably, after the auxiliary machine Bluetooth speaker discovers the host signal, the broadcast receiving module of the auxiliary machine Bluetooth speaker sends a connection application to the broadcast receiving module of the host Bluetooth speaker, and the broadcast receiving module of the host Bluetooth speaker verifies and confirms to complete networking with the auxiliary machine Bluetooth speaker.

The broadcast receiving module of the host Bluetooth speaker synchronously transmits the audio signals to the broadcast receiving modules of all the auxiliary Bluetooth speakers.

The broadcast receiving modules of the main machine Bluetooth speaker and all the auxiliary machine Bluetooth speakers synchronously send audio signals to the power amplification modules of the main machine Bluetooth speaker and all the auxiliary machine Bluetooth speakers. The power amplifier modules of the main machine Bluetooth speaker and all the auxiliary machine Bluetooth speakers push the speakers to sound, and interconnection playing is completed.

Preferably, the first DC-DC converter adopts a chip model number of SCT2630. The second DC-DC converter adopts a chip model number of XL1509. The Bluetooth module adopts the chip model of BT8922B2. The broadcast receiving module adopts the chip model of BT8962B5. The power amplifier module adopts the chip model of TPA3110D2.

Preferably, the chip SCT2630 pin EN is connected with an external power supply in parallel with the pin VIN, the pin SW is connected with an inductor and a capacitor to be an output pin PVCC, and the output pin PVCC is connected with the chip TPA3110D2.

Preferably, the pin VIN of the chip XL1509 is connected to an external power supply, and the pin OUTPUT is connected to an inductor, a diode and a resistor to form an OUTPUT pin VMCU, and the OUTPUT pin VMCU is connected to the chip BT8922B2 and the chip BT8962B5.

Preferably, the chip BT8922B2 pin DACR is connected to the chip BT8962B5 pin PB15, and the chip BT8922B2 pin DACL is connected to the chip BT8962B5 pin PB 14.

Preferably, the chip BT8962B5 pin DACR is connected to the chip TPA3110D2 pin LINP, and the chip BT8962B5 pin DACL is connected to the chip TPA3110D2 pin PINP.

Preferably, the connection capacitor of the pins BT_ANT of the chips BT8922B2 and BT8962B5 is connected to the on-board antenna.

As can be seen from the technical scheme, compared with the prior art, the technical scheme of the invention has the following beneficial effects.

The Bluetooth speaker networking system realizes the interconnection playing of a plurality of Bluetooth sound units, can set the master-slave relation of the Bluetooth sound units according to actual conditions, and is convenient to operate. The Bluetooth sound units can be connected according to the needs of users, and the sound units can be added or removed at any time, so that the number and the positions of the sound units are adaptively configured, the Bluetooth sound unit system has good expandability and flexibility, and high-quality audio experience is provided for the users.

### DESCRIPTION OF THE ACCOMPANYING DRAWINGS

In order to more clearly illustrate the embodiments of the present invention or the technical solutions in the prior art, the drawings that are required to be used in the embodiments or the description of the prior art will be briefly described below, and it is obvious that the drawings in the following description are only embodiments of the present invention, and that other drawings can be obtained according to the provided drawings without inventive effort for a person skilled in the art.

FIG. 1 is a schematic diagram of a Bluetooth speaker networking system provided by the disclosure;

FIG. 2 is a structural frame diagram of a Bluetooth sound unit provided by the disclosure;

FIG. 3 is a schematic circuit diagram of a chip SCT2630 provided by the present disclosure;

FIG. 4 is a schematic circuit diagram of a chip XL1509 provided by the present disclosure;

FIG. 5 is a schematic circuit diagram of a chip BT8922B2 provided by the present disclosure;

FIG. 6 is a schematic circuit diagram of a chip BT8962B5 according to the present disclosure;

FIG. 7 is a schematic circuit diagram of a chip TPA3110D2 according to the present disclosure.

### DETAILED DESCRIPTION OF THE EMBODIMENTS

The following description of the embodiments of the present invention will be made clearly and completely with reference to the accompanying drawings, in which it is apparent that the embodiments described are only some embodiments of the present invention, but not all embodiments. All other embodiments, which can be made by those skilled in the art based on the embodiments of the invention without making any inventive effort, are intended to be within the scope of the invention.

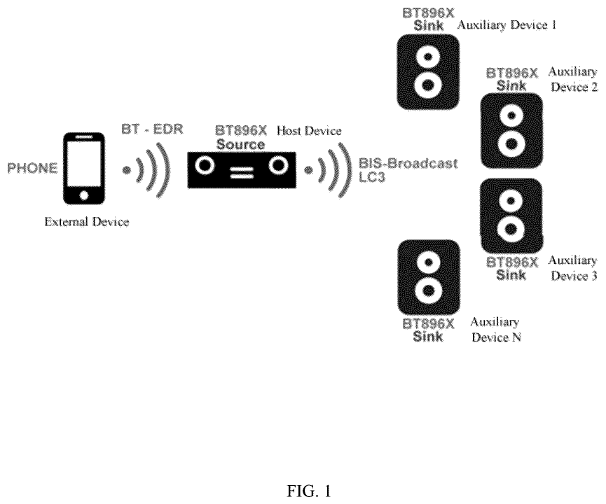

As shown in FIG. 1, this embodiment provides a Bluetooth speaker networking system, which includes a plurality of Bluetooth sound units in wireless communication connection with each other.

When all Bluetooth sound units are powered on, the Bluetooth sound units are set as auxiliary Bluetooth sound units by default.

When any one Bluetooth sound unit is connected with external equipment through Bluetooth, the Bluetooth sound unit is set as a host Bluetooth sound.

All other auxiliary machine Bluetooth sound equipment are connected with the main machine Bluetooth sound equipment, and the Bluetooth of the auxiliary machine Bluetooth sound equipment is closed.

The host Bluetooth sound synchronizes the received audio signal to all other auxiliary Bluetooth sound.

The Bluetooth speaker networking system realizes the interconnection playing of a plurality of Bluetooth sound units, can set the master-slave relation of the Bluetooth sound units according to actual conditions, and is convenient to operate. The Bluetooth sound units can be connected according to the needs of users, and the sound units can be added or removed at any time, so that the number and the positions of the sound units are adaptively configured, the Bluetooth sound unit system has good expandability and flexibility, and high-quality audio experience is provided for the users.

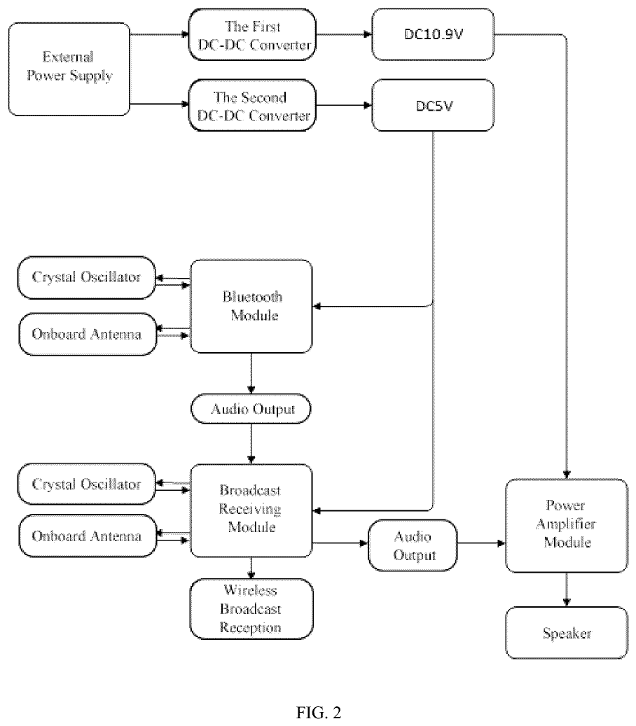

As shown in FIG. 2, the Bluetooth sound unit in this embodiment includes a power supply module, a Bluetooth module, a broadcast receiving module, a power amplifier module and a loudspeaker.

The power module includes a first DC-DC converter and a second DC-DC converter. The first DC-DC converter is connected with the power amplification module and used for reducing voltage to supply power for the power amplification module. The second DC-DC converter is connected with the Bluetooth module and the broadcast receiving module and is used for reducing voltage to supply power for the Bluetooth module and the broadcast receiving module.

The Bluetooth module is used for receiving the audio signal sent by the external equipment, is connected with the broadcast receiving module and transmits the audio signal to the broadcast receiving module. The broadcast receiving module is used for determining an auxiliary machine mode and a main machine mode of the Bluetooth sound equipment, is connected with the power amplification module and transmits an audio signal to the power amplification module; the power amplifier module is connected with a loudspeaker and drives the loudspeaker to sound.

When all the Bluetooth sound units are powered on, the broadcast receiving module sets the local Bluetooth sound unit as a secondary Bluetooth sound.

After any one of the Bluetooth sound units is connected with the peripheral through Bluetooth, the Bluetooth module sends a connection signal to the broadcast receiving module, and the broadcast receiving module receives the connection signal and sets the local Bluetooth sound unit as a host Bluetooth sound unit.

After the auxiliary machine Bluetooth speaker discovers the host signal, the broadcast receiving module of the auxiliary machine Bluetooth speaker sends a connection application to the broadcast receiving module of the host Bluetooth speaker, and the broadcast receiving module of the host Bluetooth speaker verifies and confirms to complete networking with the auxiliary machine Bluetooth speaker.

The broadcast receiving module of the main machine Bluetooth speaker synchronously transmits the audio signals to the broadcast receiving modules of all the auxiliary machine Bluetooth speakers.

The broadcast receiving modules of the main machine Bluetooth speaker and all the auxiliary machine Bluetooth speakers synchronously send audio signals to the power amplifier modules of the main machine Bluetooth speaker and all the auxiliary machine Bluetooth speakers. The power amplifier modules of the main machine Bluetooth speaker and all the auxiliary machine Bluetooth speakers push the speakers to sound, and the interconnection playing is completed.

In this embodiment, the power input voltage is 29V, the step-down voltage of the first DC-DC converter is 10.9V, and the step-down voltage of the second DC-DC converter is 5V.

The Bluetooth sound unit adopts two DC-DC converters, improves the efficiency of the power amplifier module, the Bluetooth module and the broadcast receiving module, and can work more stably and with high quality when playing audio. By adopting Audio Broadcast LE AUDIO technology, the broadcast receiving module of the Bluetooth speaker can determine the auxiliary mode and the host mode of the Bluetooth speaker, can realize classical playing of a single Bluetooth speaker and interconnection playing of a plurality of Bluetooth speakers, and can realize diversified use of the speakers according to own requirements and environment adaptation selection. The Bluetooth speaker has the advantages of being better in multifunction, integration design and tone quality output, and can provide better use experience for users, and the performance and competitiveness of the Bluetooth speaker are improved.

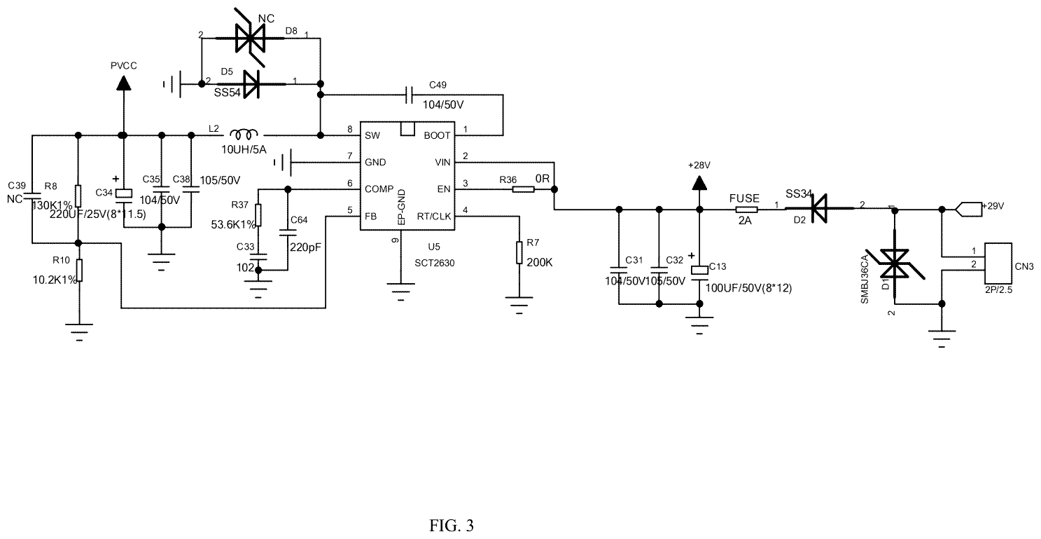

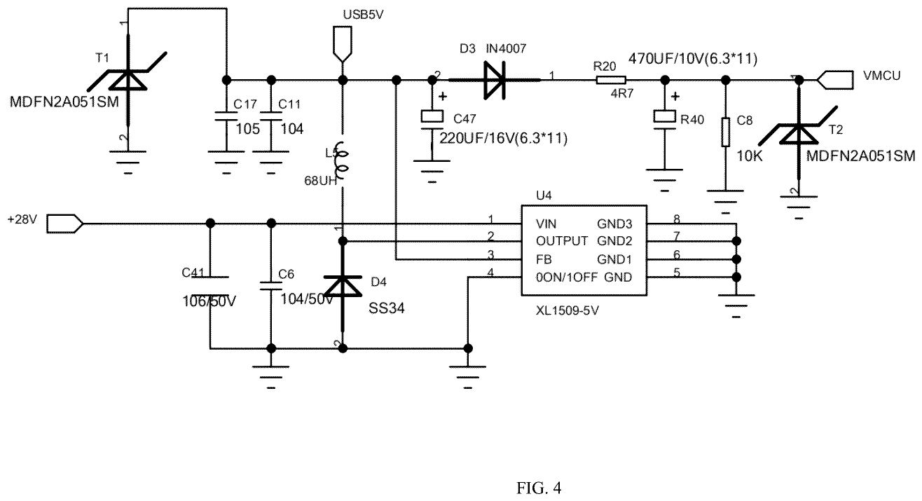

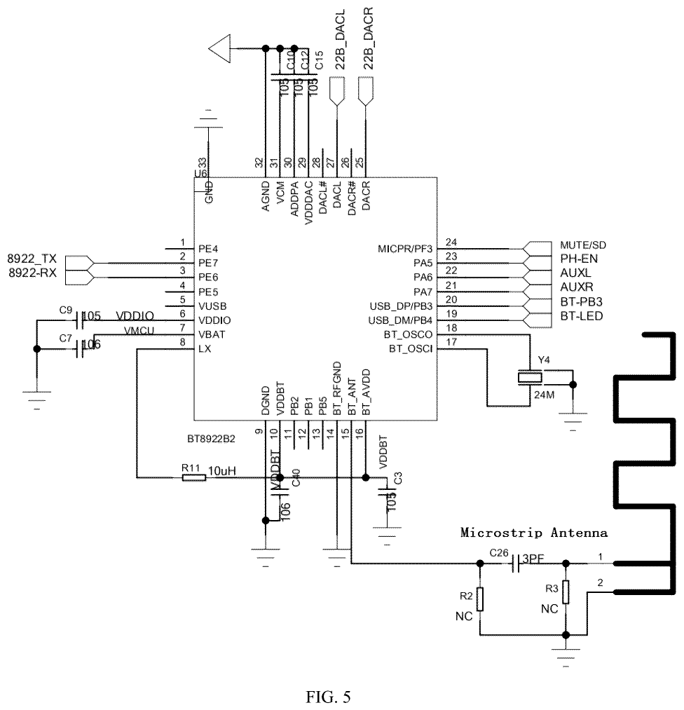

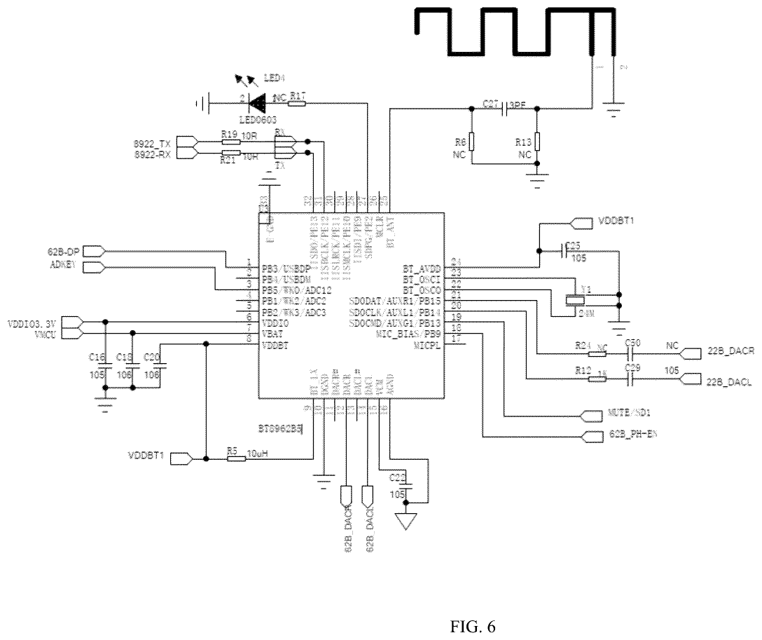

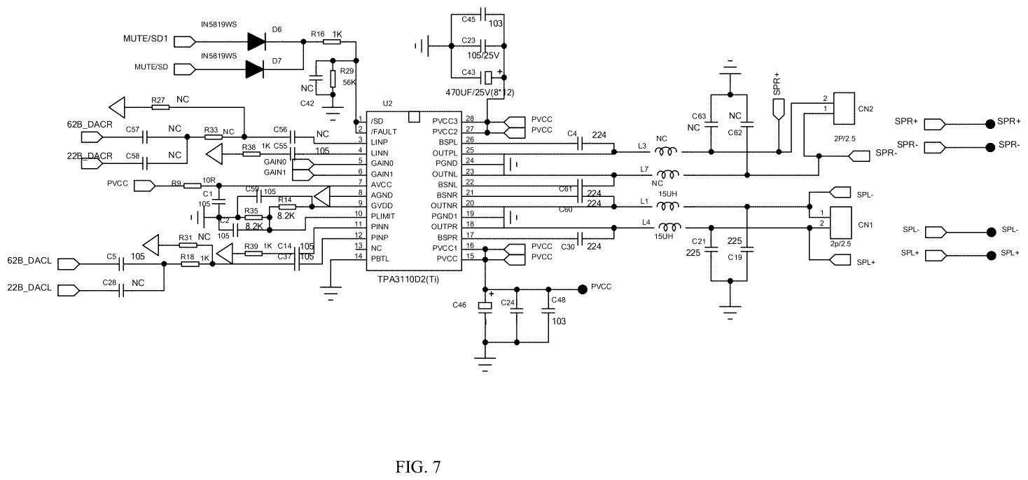

The chip model and the corresponding connection relation of each module of the speaker unit in this embodiment are further described below:
as shown in FIGS. 3-7, the first DC-DC converter adopts a chip model number of SCT2630; the second DC-DC converter adopts the chip model of XL1509; the Bluetooth module adopts the chip model of BT8922B2; the broadcasting receiving module adopts the chip model of BT8962B5; the power amplifier module adopts the chip model of TPA3110D2.

The chip SCT2630 pin EN is connected with an external power supply in parallel with the pin VIN, the pin SW is connected with an inductor and a capacitor to be an output pin PVCC, and the output pin PVCC is connected with the chip TPA3110D2.

The chip XL1509 pin VIN is connected with an external power supply, the pin OUTPUT is connected with an inductor, a diode and a resistor to be an OUTPUT pin VMCU, and the OUTPUT pin VMCU is connected with the chip BT8922B2 and the chip BT8962B5.

Chip BT8922B2 pin DACR is connected to chip BT8962B5 pin PB15, and chip BT8922B2 pin DACL is connected to chip BT8962B5 pin PB 14.

Chip BT8962B5 pin DACR is connected to chip TPA3110D2 pin link and chip BT8962B5 pin DACL is connected to chip TPA3110D2 pin PINP.

The chip BT8922B2 and the chip BT8962B5 pin BT_ANT are connected with the on-board antenna through a connecting capacitor.

The chip adopted in the embodiment has the characteristics of high performance, high integration level and high stability, can realize effective communication and cooperative work among all modules, provides stable and reliable audio signal processing and amplifying functions, and provides a comprehensive, efficient and innovative solution for the design and manufacture of audio equipment.

In this specification, each embodiment is described in a progressive manner, and each embodiment is mainly described in a different point from other embodiments, so that the same or similar parts between the embodiments are referred to each other. For the system disclosed in the embodiment, since it corresponds to the method disclosed in the embodiment, the description is relatively simple, and the relevant points refer to the description of the method section.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A Bluetooth speaker networking system, comprising:
a plurality of Bluetooth sound units in wireless communication connection with each other;
wherein when the plurality of Bluetooth sound units are powered on, the Bluetooth sound units are set as auxiliary Bluetooth sound units by default;
when any one of the plurality of the Bluetooth sound unit is connected with an external equipment through Bluetooth, the Bluetooth sound unit is set as a host Bluetooth sound; all other auxiliary machine Bluetooth sound equipment are connected with the main machine Bluetooth sound equipment, and the Bluetooth of the auxiliary machine Bluetooth sound equipment is closed;
the host Bluetooth sound synchronizes the received audio signal to all other auxiliary Bluetooth sound.

2. The Bluetooth speaker networking system of claim 1, wherein the Bluetooth speaker unit comprises a power supply module, a Bluetooth module, a broadcast receiving module, a power amplifier module and a loudspeaker;
the power module comprises a first DC-DC converter and a second DC-DC converter; the first DC-DC converter is connected with the power amplification module and is used for reducing voltage to supply power for the power amplification module; the second DC-DC converter is connected with the Bluetooth module and the broadcast receiving module and is used for reducing voltage to supply power for the Bluetooth module and the broadcast receiving module;
the Bluetooth module is used for receiving an audio signal sent by the external equipment, and is connected with the broadcast receiving module and transmits the audio signal to the broadcast receiving module; the broadcast receiving module is used for determining an auxiliary machine mode and a main machine mode of the Bluetooth sound equipment, is connected with the power amplification module and transmits the audio signal to the power amplification module; the power amplifier module is connected with the loudspeaker and drives the loudspeaker to sound.

3. The Bluetooth speaker networking system according to claim 2, wherein the broadcast receiving module sets the local Bluetooth speaker unit as a sub-set Bluetooth speaker when all Bluetooth speaker units are powered on;
after any one of the Bluetooth sound units is connected with the peripheral through Bluetooth, the Bluetooth module sends a connection signal to the broadcast receiving module, the broadcast receiving module receives the connection signal, and the local Bluetooth sound unit is set as a host Bluetooth sound unit.

4. The Bluetooth speaker networking system according to claim 3, wherein, after the auxiliary Bluetooth speaker finds a host signal, the broadcast receiving module of the auxiliary Bluetooth speaker sends a connection request to the broadcast receiving module of the host Bluetooth speaker, and the broadcast receiving module of the host Bluetooth speaker performs verification and completes networking with the auxiliary Bluetooth speaker;
the broadcast receiving module of the host Bluetooth speaker synchronously transmits the audio signals to the broadcast receiving modules of all the auxiliary Bluetooth speakers;
the broadcast receiving modules of the main machine Bluetooth speaker and all the auxiliary Bluetooth speakers synchronously send audio signals to the power amplification modules of the main machine Bluetooth speaker and all the auxiliary machine Bluetooth speakers; the power amplifier modules of the main machine Bluetooth speaker and all the auxiliary machine Bluetooth speakers push the speakers to sound, and interconnection playing is completed.

5. The Bluetooth speaker networking system according to claim 2, wherein the first DC-DC converter is of a chip type of SCT2630; the second DC-DC converter adopts a chip model number of XL1509; the Bluetooth module adopts the chip model of BT8922B2; the broadcast receiving module adopts the chip model of BT8962B5; the power amplifier module adopts the chip model of TPA3110D2.

6. The Bluetooth speaker networking system according to claim 5, wherein the chip SCT2630 pin EN is connected to an external power supply in parallel with pin VIN, the pin SW is connected to an inductor and a capacitor as output pins PVCC, and the output pins PVCC are connected to the chip TPA3110D2.

7. The Bluetooth speaker networking system according to claim 5, wherein the pin VIN of the chip XL1509 is connected to an external power source, the pin OUTPUT is connected to an inductor, a diode and a resistor as an OUTPUT pin VMCU, and the OUTPUT pin VMCU is connected to the chip BT8922B2 and the chip BT8962B5.

8. The Bluetooth speaker networking system according to claim 5, wherein the pin DACR of the chip BT8922B2 is connected to the pin PB15 of the chip BT8962B5, and the pin DACL of the chip BT8922B2 is connected to the pin PB14 of the chip BT8962B5.

9. The Bluetooth speaker networking system of claim 5, wherein the BT8962B5 pin DACR is coupled to the TPA3110D2 pin link, and the BT8962B5 pin DACL is coupled to the TPA3110D2 pin PINP.

10. The Bluetooth speaker networking system according to claim 5, wherein the BT8922B2 chip and the BT8962B5 pin bt_ant connection capacitor are connected to an on-board antenna.
